(19) United States
(12) Patent Application Publication
(10) Pub. No.: US 2025/0056256 A1
(43) Pub. Date: Feb. 13, 2025

(54) SPLIT INFERENCE CONFIGURATION CONTROL METHOD AND APPARATUS IN WIRELESS COMMUNICATION SYSTEM

(71) Applicant: Samsung Electronics Co., Ltd., Gyeonggi-do (KR)

(72) Inventor: Eric YIP, Gyeonggi-do (KR)

(21) Appl. No.: 18/800,457

(22) Filed: Aug. 12, 2024

(30) Foreign Application Priority Data
Aug. 11, 2023 (KR) 10-2023-0105671

(51) Int. Cl. H04W 24/02; H04W 72/20; H04W 72/51

(52) U.S. Cl. CPC H04W 24/02; H04W 72/20; H04W 72/51

(57) ABSTRACT

Disclosed is a method and apparatus for providing a media service. A method performed by a network includes identifying an AI model corresponding to a service, negotiating a split inference configuration with a UE, performing a split inference with the UE, based on the AI model and the split inference configuration, and providing the service based on a result of the split inference.

### CROSS-REFERENCE TO RELATED APPLICATION

This application is based on and claims priority under 35 U.S.C. § 119 to Korean Patent Application No. 10-2023-0105671, filed on Aug. 11, 2023, in the Korean Intellectual Property Office, the disclosure of which is incorporated herein by reference in its entirety.

### BACKGROUND

### 1. Field

The disclosure relates generally to wireless communication, and more particularly, to fifth generation (5G) network systems for multimedia, architectures and procedures for artificial intelligence (AI) model or machine learning (ML) model transfer and delivery over the 5G network systems.

### 2. Description of the Related Art

Based on the development of wireless communication, technologies have primarily been developed for services targeting humans, such as voice calls, multimedia services, and data services. Since the commercialization of 5G communication systems, the number of things connected to communication networks has exponentially increased. Such connected things may include vehicles, robots, drones, home appliances, displays, smart sensors connected to various infrastructures, construction machines, and factory equipment. Mobile devices are expected to evolve in various form-factors, such as augmented reality (AR) glasses, virtual reality (VR) headsets, and hologram devices. To provide various services by connecting hundreds of billions of devices and things in the sixth generation (6G) era, there have been ongoing efforts to develop improved 6G communication systems, also referred to as beyond-5G systems.

6G communication systems, which are expected to be commercialized around 2030, will have a peak data rate of terahertz (THz) (1,000 gigahertz)-level bits per second (bps) and a radio latency less than 100 microseconds (usec), and thus will be 50 times as fast as 5G communication systems and have 1/10 of the radio latency of 5G systems.

To realize such a high data rate and an ultra-low latency, it has been considered to implement 6G communication systems in THz bands, such as 95 GHz to 3 THz bands. It is expected that, due to more extreme path loss and atmospheric absorption in the THz bands than those in millimeter wave (mmWave) bands introduced in 5G, technologies capable of securing the signal transmission distance will become more crucial. Thus, it is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. There has been ongoing discussion on new technologies for improving the coverage of THz-band signals, such as metamaterial-based lenses and antennas, orbital angular momentum (OAM), and reconfigurable intelligent surface (RIS).

To improve the spectral efficiency and the overall network performances, the following technologies have been developed for 6G communication systems: a full-duplex technology for enabling an uplink transmission and a downlink transmission to simultaneously use the same frequency resource, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of AI in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, etc.) over the network. Through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will give rise to the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

AI is a general concept defining the capability for a system to act based on the context in which a task has to be done, meaning the value or state of different input parameters, and the past experience of achieving the same task with different parameter values and the record of potential success with each parameter value.

ML is often described as a subset of AI, in which an application has the capacity to learn from the past experience. This learning feature usually starts with an initial training phase to ensure a minimum level of performance when it is placed into service.

Recently, AI/ML has been introduced and generalized in media related applications, ranging from legacy applications such as image classification, speech/face recognition, to more recent ones such as video quality enhancement. As research into this field matures, an increasing number of complex AI/ML-based applications requiring higher computational processing can be expected. Such processing involves significant amounts of data, not only for the inputs and outputs into the AI/ML models, but also for the increasing data size and complexity of the AI/ML models. This increasing amount of AI/ML related data, together with a need for supporting processing intensive mobile applications, such as VR, AR, and mixed reality (MR), and gaming, highlights the importance of handling certain aspects of AI/ML processing by the server over a 5G system, to meet the required latency requirements of various applications.

Current implementations of AI/ML are mainly proprietary solutions, enabled via applications without compatibility with other market solutions. To support AI/ML for multimedia applications over 5G, AI/ML models should support compatibility between UE devices and application providers from different MNOs. Moreover, AI/ML model delivery for AI/ML media services should support media context, UE status, and network status based selection and delivery of the AI/ML model. The processing power of UE devices is also a limitation for AI/ML media services, since next generation media services, such as AR, are typically consumed on lightweight, low processing power devices, such as AR glasses, for which long battery life is also a major design hurdle/limitation.

Due to such limitations, AI inferencing for such media applications will commonly leverage network resources such as the cloud or edge, for split inferencing between the network and UE device, where a part of the AI model is inferenced in the network, and the remainder of the AI model is inference on the UE device or vice-versa.

For such scenarios where inferencing needs to occur on the UE device, either the full or partial split AI model must be delivered to the UE from the network.

The decision of how to split an AI model for split inferencing between two different entities (one of which should include a UE) highly depends on the characteristics of the AI model, as well as the UE's capability and resource availability. As such, after the service announcement for the service, negotiation and configuration of the split inference (i.e. the order of the split inference, either in UE first or in server first), and also the necessary delivery sessions for the required data types is vital in the decisions and configurations for the split inference AI media service.

Generally, however, AI inferencing for media processing is computationally heavy, requiring leverage of network resources. For example, a conventional AI model needs to be delivered from network to UE as user plane data. Split AI inferencing between a UE and network requires negotiations and configurations to decide the split configuration(s) between the UE and network. Split configurations are dependent mainly on the nature of the AI for media service (e.g., vision application, or video enhancement application etc.), but also on the UE device capabilities, as well as issues related to network uplink/downlink availability, and security/privacy issues of uploading user private media data for AI processing in the server.

Relatedly, there are no profiles in the conventional art for AI/ML which define the different split inference configurations between the UE and network, or the network and UE.

Even if a specific split inference configuration is known, there is no method in the conventional art to configure the necessary delivery sessions for the required data types and their delivery directions, based on the requirements of the split inference configuration. As previously noted, current implementations of AI/ML are mainly proprietary solutions, enabled via applications without compatibility with other market solutions. To support AI/ML for multimedia applications over 5G, there is a need in the art for AI/ML models to support compatibility between UEs and application providers from different mobile network operators (MNOs).

### SUMMARY

The disclosure has been made to address at least the above-mentioned problems and/or disadvantages and to provide at least the advantages described below.

Accordingly, an aspect of the disclosure is to provide mechanisms for different split inference configurations between the UE and network, or the network and UE.

An aspect of the disclosure is to provide methods to differentiate between the different data types required to be delivered between the UE and the network, or the network and the UE, as well as their related quality of service (QOS) requirements.

An aspect of the disclosure is to provide a method and apparatus in which different split inference configurations between the UE and network are provided, and negotiations of the required data types and their delivery sessions, including dynamic configurations during the service, are also provided.

In accordance with an aspect of the disclosure, a method performed by a network for providing a service includes identifying an AI model corresponding to the service, negotiating a split inference configuration with a UE, performing a split inference with the UE, based on the AI model and the split inference configuration, and providing the service based on a result of the split inference.

In accordance with an aspect of the disclosure, a method performed by a UE for providing a service includes negotiating a split inference configuration with a network, performing a split inference with the network, based on an AI model corresponding to the service and the split inference configuration, and providing the service based on a result of the split inference.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates a 5G media streaming architecture to which the disclosure is applied;

FIG. 2 illustrates a 5G media streaming general architecture to which the disclosure is applied;

FIG. 3 illustrates a high level procedure for media downlink streaming to which the disclosure is applied;

FIG. 4 illustrates a method for establishment of a unicast media downlink streaming session to which the disclosure is applied;

FIG. 5 illustrates an AI/ML media service method according to an embodiment;

FIG. 6 illustrates a delivery of an AI model to a UE according to an embodiment;

FIG. 7 illustrates a method in which inferencing required for the AI media service is split between the network and UE according to an embodiment;

FIG. 8 illustrates an AI procedure for media architecture according to an embodiment;

FIG. 9 illustrates a method for delivery of an AI model according to an embodiment;

FIG. 10 illustrates split inference configurations between a UE and network according to an embodiment;

FIG. 11 illustrates a method corresponding a split inference configuration in FIG. 10, according to an embodiment;

FIG. 12 illustrates a method corresponding a split inference configuration in FIG. 10, according to an embodiment;

FIG. 13 illustrates an establishment of delivery pipelines according to an embodiment; and

FIG. 14 is a block diagram of an entity, according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure.

Descriptions of well-known functions and constructions may be omitted for the sake of clarity and conciseness. Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

The disclosure may be embodied in various forms and should not be construed as being limited to the embodiments set forth herein. Rather, these embodiments are provided so that this disclosure will be thorough and complete, and will fully convey the concept of the disclosure to one of ordinary skill in the art.

Throughout the specification, like reference numerals refer to like elements.

As used herein, the term unit denotes a software element or a hardware element such as a field-programmable gate array (FPGA) or an application-specific integrated circuit (ASIC) and performs a certain function. However, the term unit is not limited to software or hardware. The unit may be formed so as to be in an addressable storage medium or may be formed so as to operate one or more processors. Thus, for example, the term unit may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and units may be combined into the smaller number of elements and units, or may be divided into additional elements and units. The elements and units may be embodied to reproduce one or more central processing units (CPUs) in a device or security multimedia card. Also, in an embodiment of the disclosure, the unit may include at least one processor.

Throughout the specification, function or an apparatus or a server for providing a service may also be referred to as an entity.

In particular, the mechanisms described herein include the following:

Negotiating the splitting of the AI inference process after the AI model required for the service is identified, and after the AI media capabilities and functions of the UE and network are discovered.

During the negotiation process, control messages are exchanged between the network and UE.

Once the control messages are fully exchanged and the split inference configuration is agreed upon, the information from the control messages is used to establish the corresponding pipelines for the different data types according to the control message(s).

The different split inference configurations possible for an AI media split inferencing service.

The control messages are exchanged between the UE and network, including the exchange procedures between the UE and network, as well as the information carried by the messages.

Information from the control messages is used to establish delivery pipelines for the corresponding required data types between the UE and network in either the uplink or the downlink.

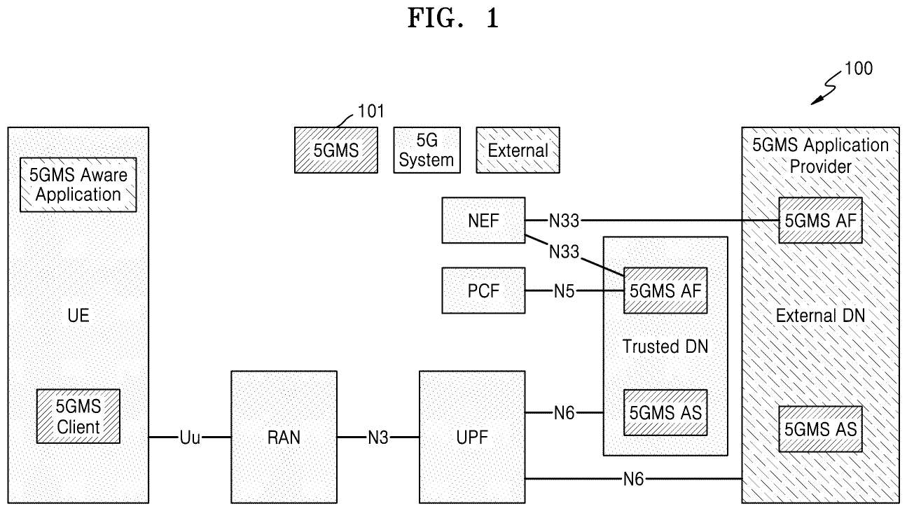

FIG. 1 illustrates a 5G media streaming architecture 100 to which the disclosure is applied.

Referring to FIG. 1, the overall 5G media streaming architecture 100 in the relevant Standard, representing the specified 5GMS 101 functions within the 5GS as defined in the relevant Standard, is shown.

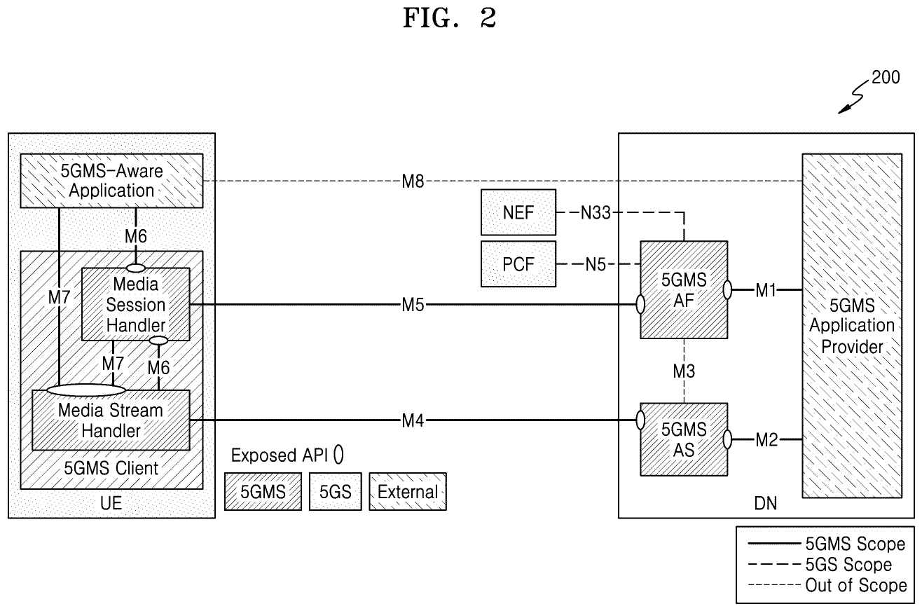

FIG. 2 illustrates a 5G media streaming general architecture 200 to which the disclosure is applied.

Referring to FIG. 2, the 5G media streaming 201 general architecture in the relevant Standard, identifying which media streaming functional entities and interfaces are specified within the specification is shown.

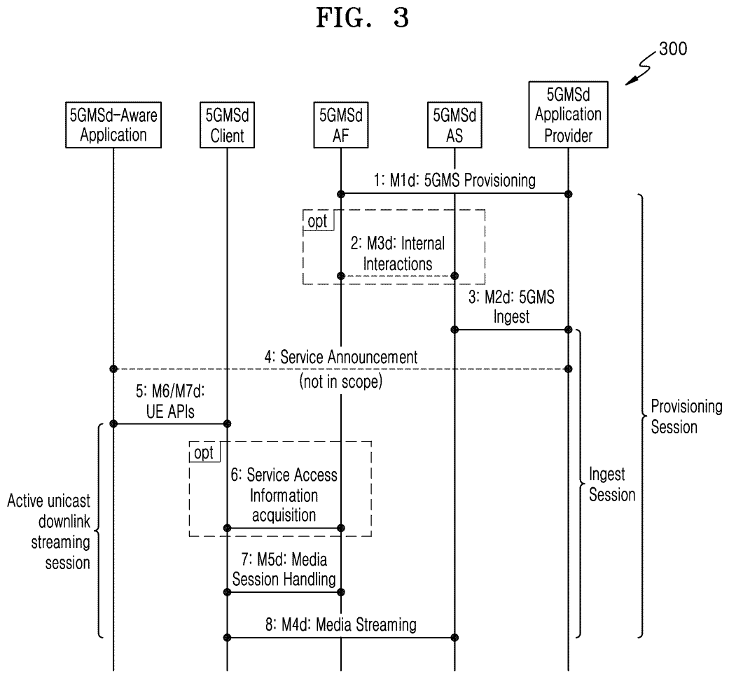

FIG. 3 illustrates a high level procedure 300 for media downlink streaming to which the disclosure is applied.

Referring to FIG. 3, the high level procedure 300 for media downlink streaming as specified in the relevant Standard is shown.

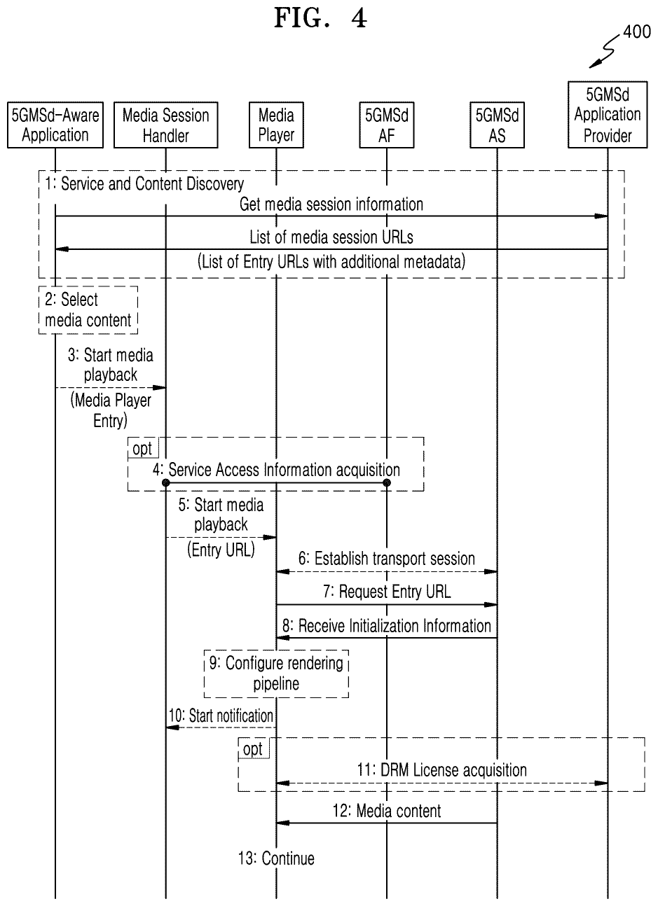

FIG. 4 illustrates a method 400 for establishment of a unicast media downlink streaming session to which the disclosure is applied.

Referring to FIG. 4, the baseline procedure describing the establishment of a unicast media downlink streaming session as defined in the relevant Standard is shown.

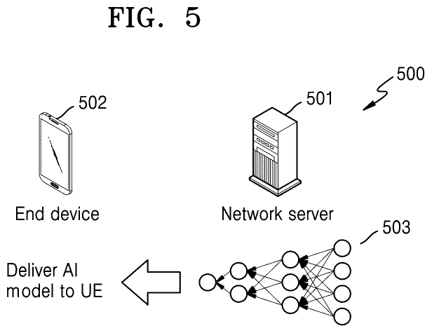

FIG. 5 illustrates an AI/ML media service method 500 according to an embodiment.

Referring to FIG. 5, a simple AI/ML media service method 500 in which an AI/ML model is required to be delivered from the network server 501 to the UE 502 is shown. Upon receiving the AI model 503, the UE 502 performs the inferencing of the model, feeding the relevant media as an input into the AI model 503.

For example, John is in Seoul, South Korea for his summer vacation, and he is in Jamsil wanting to visit Lotte Tower for sightseeing. John cannot read Korean and finds it difficult to navigate his way to Lotte Tower. John takes out his UE and opens an AR navigation service. His network operator provides the service via 5G, and through the analysis of different information, a suitable AI model is delivered to his UE. Such information includes information available from the network, such as John's UE location, his charging policy, network availability and conditions (bandwidth, latency) etc., his UE's processing capabilities and status, as well as the media properties which will be used as the input to the AI model. Once the AI model is delivered to John's phone, the AR navigation service initiates the camera on the phone to capture John's surroundings. The captured video from the phone's camera is fed as the input into the AI model, and the AI model inferencing is initiated. The output of the AI model provides direction labels (such as navigation arrows) which are shown as overlays in the phone's screen live camera to guide John to Lotte Tower. Road signs in Korean are also overlayed by English labels output from the AI model.

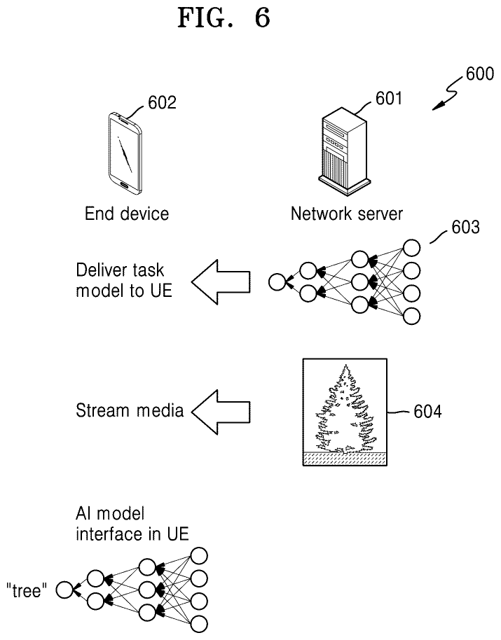

FIG. 6 illustrates a method 600 of delivery of an AI model to a UE according to an embodiment.

Referring to FIG. 6, a method 600 in which an AI model 603 is delivered by the network server 601 to the UE 602 and media (such as video) is also streamed to the UE 602 is shown. In the UE 602, the streamed media 604 is fed as an input into the received AI model 603 for processing.

The AI model 603 may perform any media related processing, such as video upscaling, video quality enhancement, vision applications such as object recognition, and facial recognition.

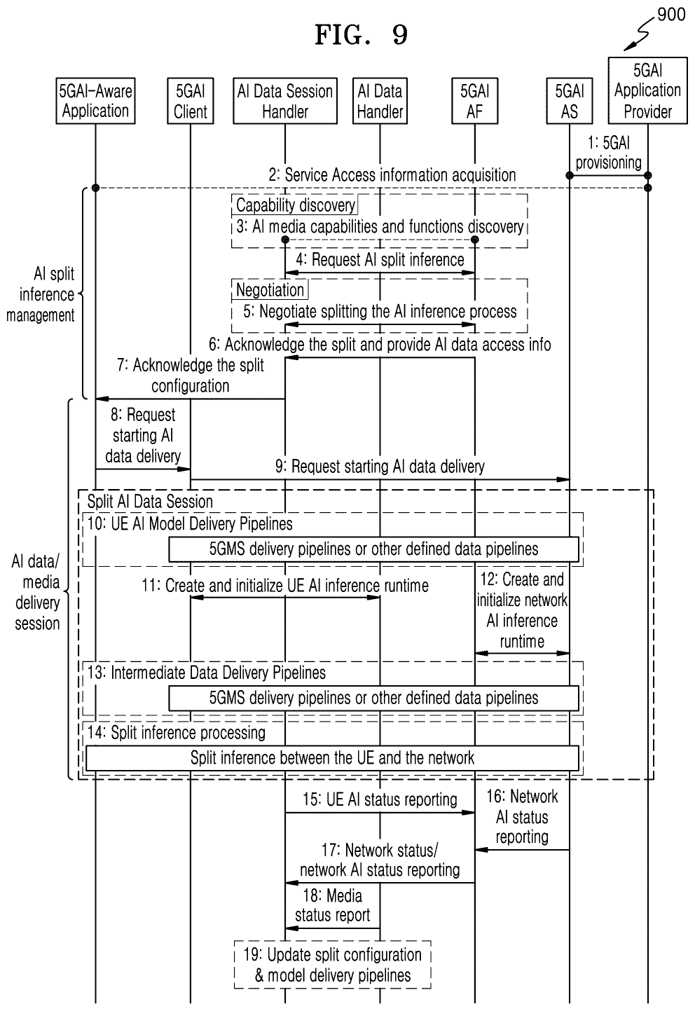

A brief description of the method, described below in detail in FIG. 9, is as follows:
Service announcement
Request/selection by UE or network (which task the UE wishes to perform, considers media requirements, network status parameters, UE status parameters, network or UE selects suitable AI model)
Provision & ingest model in network
Provision media in network
Session(s) establishment(s)
Delivery AI model from network to UE
Configure media session downlink
Stream media from network
AI media inference in UE

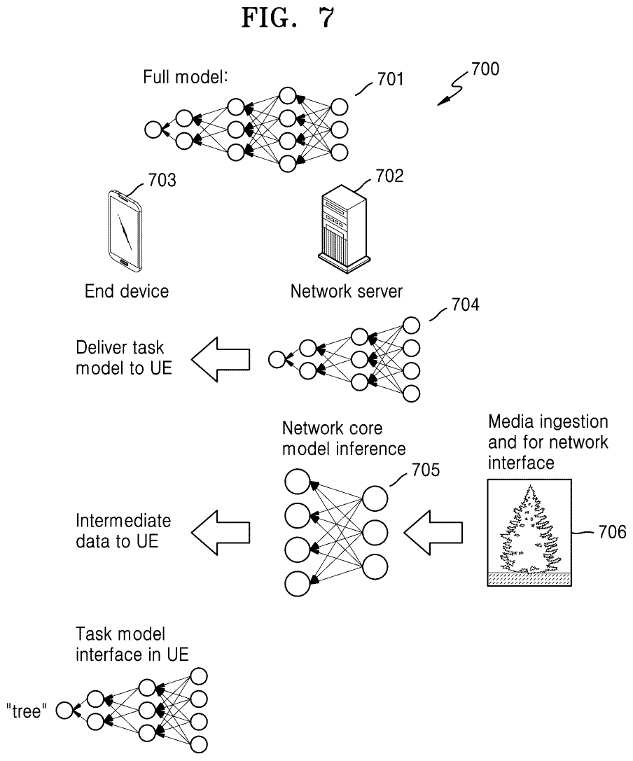

FIG. 7 illustrates a method 700 in which inferencing required for the AI media service is split between the network server and UE according to an embodiment.

Referring to FIG. 7, a portion 704 of the full AI model 701 to be inferenced on the UE 703 is delivered from network server 702 to the UE 703. Another portion 705 of the full AI model 701 to be inferenced in the network server 702 is provisioned by the network to an entity which performs the inferencing in the network. The media for inferencing is firstly provisioned and ingested by the network to the network inferencing entity, when feeds the media 706 as an input into the network portion of the AI model. The output of the network side inference (intermediate data) is then sent to the UE 703, which received this intermediate data and feeds it as an input into the UE side portion of the AI model, hence completing the inference of the full AI model 701.

In this method, the split decision and configuration is negotiated between the UE 703 and the network. A brief description of the method, described in detail below in reference to FIG. 9, is as follows:
Service announcement
Request/selection by UE (which task it wants to perform, gives media requirements, AF selects suitable model head)
Provision UE task model head and core model in network
Provision media in network
Split configuration setup & establishment
Session(s) establishment(s)
Configure intermediate data session downlink
Download/stream model head from network
Perform network core model inference
Stream intermediate data from network
Task model inference in UE

In one split configuration example, an AI model service may consist of a core portion, as well as a task specific portion (e.g. traffic sign recognition task, or facial recognition task), where the core portion of the AI model is common to multiple possible tasks. In this case, the split configuration may combine the core and task portions in a manner such that the network performs the inference of the core portion of the model, and the UE receives and performs the inference of the task portion of the model.

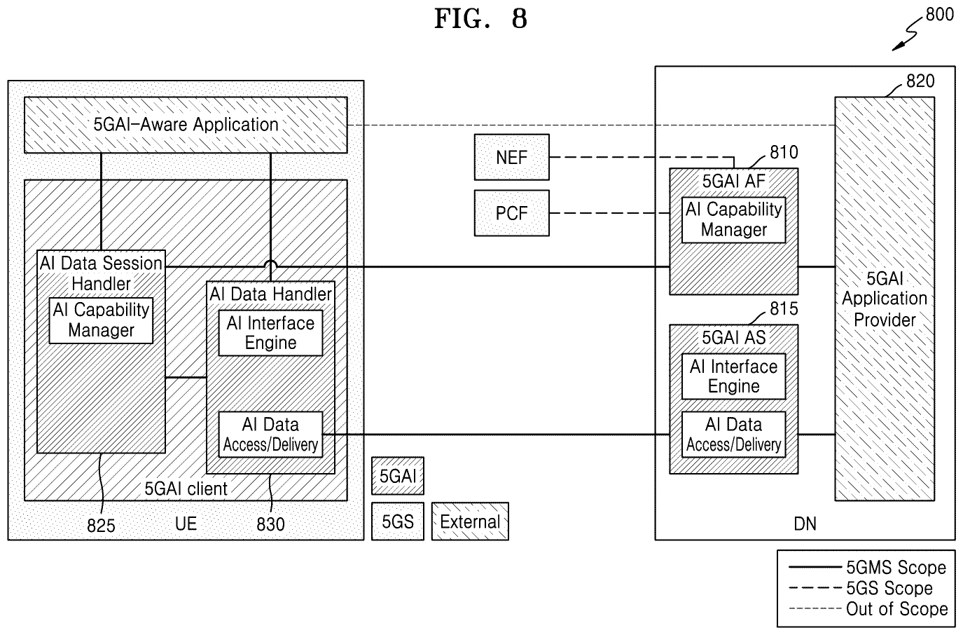

FIG. 8 illustrates an AI procedure 800 for media architecture according to an embodiment.

Referring to FIG. 8, an AI for media (AI4Media) architecture which identifies the various functional entities and interfaces for enabling AI model delivery for media services disclosed herein is shown.

5GAI Application Function (810): An AF similar to that defined in the relevant Standard, dedicated to AI media services. Typically provides various control functions to the AI Data Session Handler 825 on the UE and/or to the 5GAI Application Provider 820. It may interact with other 5GC network functions, such as a data collection proxy (DCP) function entity (which interacts with the AI/ML Endpoint and/or 3GPP Core Network to collect information required for the 5GAI AF 810). The DCP may or may not include a network data analytics function (NWDAF). The 5GAI AF 810 may contain logical subfunctions such as an AI Capability Manager, which handles the negotiation and handling of capability related data and decision in the network, and also between the network and UE.

5GAI Application Server (AS) (815): An AS dedicated to AI media services, which hosts 5G AI media (sub) functions, such as the AI Data Delivery/access function and AI Inference Engine. The 5GAI AS 815 typically supports AI model hosting by ingesting AI models from an AI Media Application Provider 820, and egesting models to other network functions for network inferencing, such as the Media AS 815. In addition to those described above, the 5GAI AS 815 may also contain Media AS functionalities and an AI Inference Engine subfunction which performs full or partial inferencing on the network. 5GAI Media Application Provider (820): External application, with content-specific media functionality, and/or AI-specific media functionality (AI model creation, splitting, updating etc.).

The 5GAI Client in the UE includes:

AI Data Session Handler (825): a function on the UE that communications with the 5GAI AF to establish, control and support the delivery of an AI model session, and/or a media session, and may perform additional functions such as consumption and quality of experience (QoE) metrics collection and reporting. The AI Data Session Handler 825 may expose APIs that can be used by the 5GAI Aware Application. It may contain logical subfunctions such as an AI Capability Manager, which handles the negotiation and handling of capability related data and decision internally in the UE, and also between the UE and network.

AI Data Handler (830): a function on the UE that communicates with the AI AS 815 to download/stream (or even upload) the AI model data, and may provide APIs to the 5GAI Aware Application for AI model inferencing, and to the AI Data Session Handler 825 for AI model session control in the UE, and also the subfunctions AI Data Access Function for accessing AI model data such as topology data and or AI model parameters (weights, biases), and AI Inference Engine for inferencing in the UE.

Alternatively, the AI inference engine in the UE may exist outside the AI Data Handler or in another function in the UE.

Alternatively, the AI engine in the network may exist outside the 5GAI AS.

FIG. 9 illustrates a method for delivery of an AI model according to an embodiment.

Referring to FIG. 9, a method 900 for the delivery of an AI model with configurations between the network and UE such that the AI model can be delivered in a manner described in reference to FIG. 7 is shown.

In step 1, a service provisioning and announcement of AI media service between the 5GAI AF (application function) and the 5GAI application provider is performed.

In step 2, service access information acquisition is performed. A required AI model for the service is known in the service access information (AI model known). In this step, the available or required AI model(s) for the service can be made known to the UE, by means of information made available via a uniform resource locator (URL) link pointing to a file or manifest which may last such available AI models. The received information may already contain AI model specific information, such as the size of the AI model network, including the number of layers contained in the AI model structure, the number of nodes and links in each layer, the complexity of each layer in the AI model (i.e. the number of free parameters), the possible split points for the model for split inferencing, and the AI model target inference delay. There may be additional steps performed for model request/subscribe, building/ingesting adapted model if not available, and model selection.

In step 3, cloud/edge and client AI media inferencing capabilities and functions are discovered.

In step 4, an AI split inference is requested between the AI data session handler and the 5GAI AF.

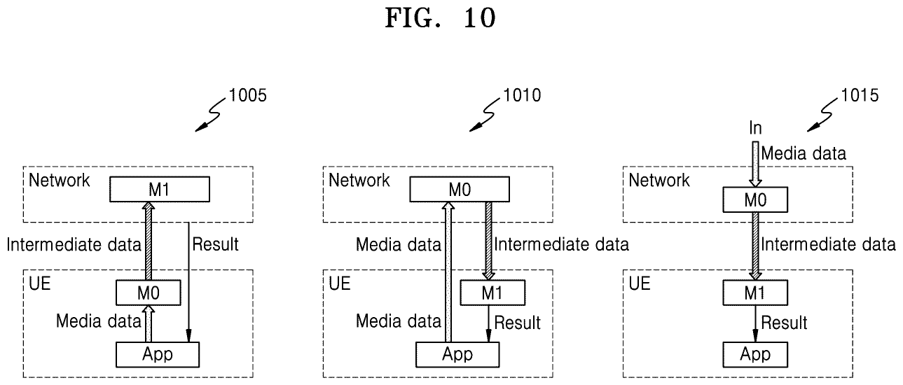

In step 5 splitting the AI media inference process is negotiation between the AI data session handler and the 5GAI AF.
Three different split inference configurations are described below in reference to FIG. 10.

A split point may also be decided during this stage, and the requirements for such a split point decision maybe that such as the total AI model target inference delay (or latency) for the service. To decide a split point, data received from steps 2, 3, 4 and 5 may be used for various calculations on deciding a split point, either in the UE or in the network, or both.

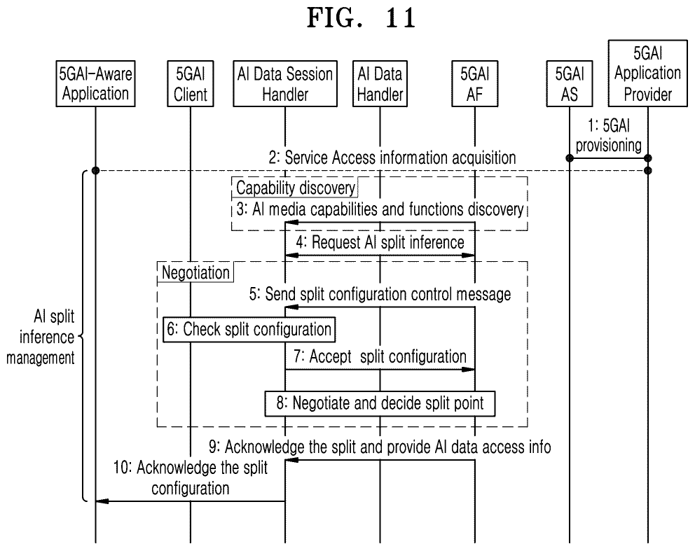

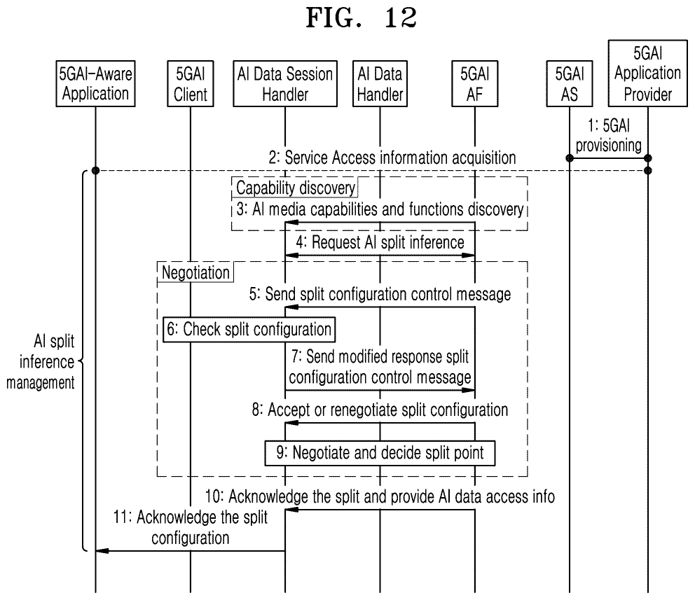

Negotiation of the split inference configuration may occur in the exchange of configuration exchange messages as shown in FIGS. 11 and 12.

In step 6, the split is acknowledged and the AI data split inferencing access info is provided.

In step 7, the split is acknowledged.

In step 8, the start of AI data/media delivery is requested.

In step 9, the UE (5GAI client) requests the start of the AI data delivery from the network.

In steps 10-14, the configuration of the AI model and data delivery pipelines may include the same parameters, procedures and configurations as described in step 5.

In step 15, the UE reports its AI status to the network.

In step 16, the AI split inference related status on the network side is also reported to the AF.

In step 17, the network related AI status report is sent to the UE.

In step 18, the media status is also aggregated by the AI data session handler.

In step 19, an update of the split configuration (e.g. changing the split point for split inferencing) may occur. The control signaling of this split point re-configuration (or dynamic configuration) may utilize the metadata as described in step 5.

FIG. 10 illustrates split inference configurations between a UE and network according to an embodiment.

Referring to FIG. 10, three difference split inference configurations 1005, 1010 and 1015 between the UE and the network are shown. Each configuration shows an AI model which has been split into two different partial models, M0 and M1. M0 is the first part of the partial AI model, and M1 is the second final part of the partial AI model. These configurations are defined through a combination of 4 different data types for the service, including media data (audio and/or video), AI model data, AI intermediate data, which results from the partial inference of an AI model, i.e. the output of a split partial AI model, and AI inference output data (result), which is the final output of the inference of the complete AI model.

The configurations are also defined by the delivery requirements of these data types, whether they need to be delivered between the UE and the network, and in what manner (with respect to the UE), such as downlink, uplink, or no pipeline required.

Table 1 below shows an example of the different split inference configurations possible according to the different data types for the service.

TABLE 1

| Media | Intermediate | |
|---|---|---|
| Source | Data | Output Data |
| Server (X) | DL | X (UE consumed) or UL (server consumed |
| | | [reporting]) |
| Server (DL) | UL | X (server consumed) or DL (UE consumed) |
| UE (UL) | DL | X (UE consumed) or UL (server consumed |
| | | [reporting]) |
| UE (X) | UL | X (server consumed) or DL (UE consumed) |

NOTE:
media and intermediate data pipeline directions cannot be the same

When the media source originates in the server, the server first performs partial inferencing, and intermediate data is delivered to the UE. The UE performs the remainder of the partial inferencing, and the output data is either consumed by the UE, or is sent back to the server either for reporting or other purposes.

When the media source originates in the server, the server may send the source to the UE without AI inferencing. The UE will perform the first part of the partial inferencing, before sending the corresponding intermediate data output to the server via uplink. The server receives this intermediate data, and performs the remainder of the partial inferencing. The inferencing result is either consumed by the server, or sent back to the UE via downlink where it is consumed.

When the media source originates in the UE, the UE may send the source to the server without AI inferencing, via uplink. The server will perform the first part of the partial inferencing, before sending the corresponding intermediate data output to the UE via downlink. The UE receives this intermediate data, and performs the remainder of the partial inferencing. The output data is either consumed by the UE, or also sent back to the server either for reporting or other purposes.

When the media source originates in the UE, the UE first performs partial inferencing, and intermediate data is delivered to the server via uplink. The server performs the remainder of the partial inferencing, and the output data is either consumed by the server, or also sent back to the UE for consumption via downlink.

FIG. 11 illustrates a method corresponding a split inference configuration in FIG. 10, according to an embodiment.

FIG. 12 illustrates a method corresponding to a split inference configuration in FIG. 10, according to an embodiment.

Referring to FIGS. 11 and 12, further details on the negotiation procedure in step 5 in FIG. 10 are shown.

Referring to FIG. 11, as part of the negotiation procedure:

In step 5, a split configuration control message is sent from the server AF to the AI data session handler on the UE.

in step 6, the UE (entities on the UE e.g. the client and/or the data session handler) parses the split configuration control message and checks the split inference configuration as requested/suggested by the server.

In step 7, the UE accepts the suggested configuration from the server and sends an accept confirmation response to the server.

In step 8, the UE and server may then negotiate and determine a specific split point for the server, according to the agreed split inference configuration.

Referring to FIG. 12, as part of the negotiation procedure:

In step 5, a split configuration control message is sent from the server AF to the AI data session handler on the UE in step 6, the UE (entities on the UE e.g. the client and/or the data session handler) parses the split configuration control message, and checks the split inference configuration as requested/suggested by the server

In step 7, the UE determines not to accept the suggested configuration from the server and sends a modified split configuration control message to the server as a response.

In step 8, the server either accepts the modified split configuration as suggested in the control message from the UE in the previous step by sending an accept response, or renegotiates the split configuration by sending another split configuration control message. and this process is repeated.

In step 9, the UE and server may then negotiate and determine a specific split point for the server, according to the agreed split inference configuration.

In FIGS. 11 and 12, once the split configuration is agreed between both the UE and server, the corresponding AI data media delivery session pipelines are setup between the UE and server, according to the final accepted control message.

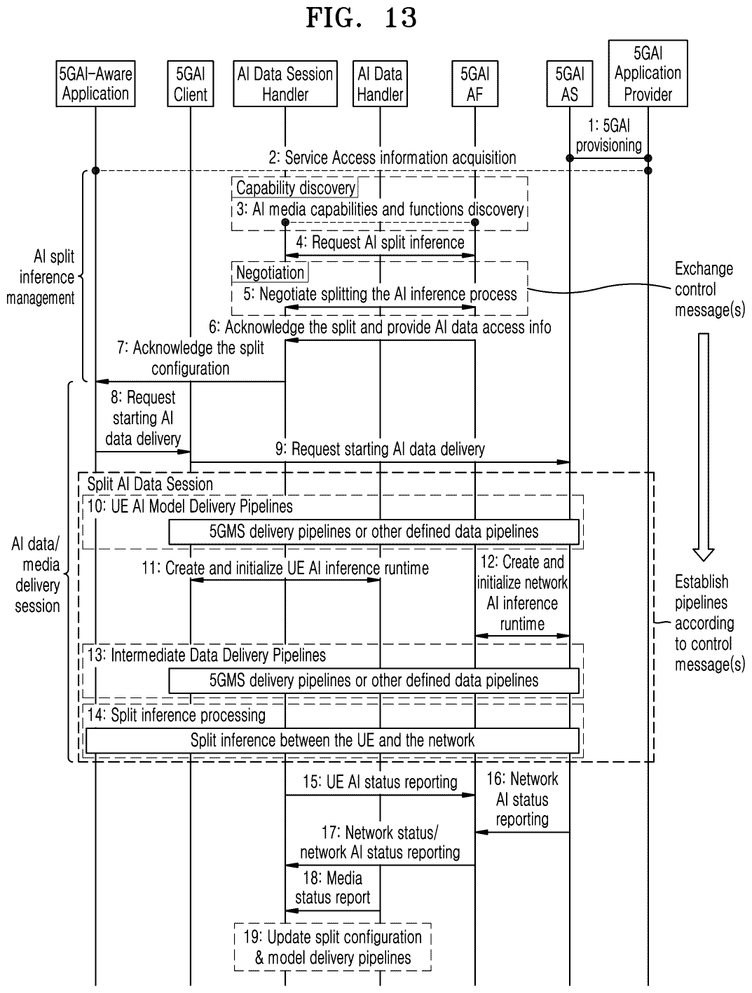

FIG. 13 illustrates an establishment of delivery pipelines according to an embodiment.

Referring to FIG. 13, the establishment of delivery pipelines in steps 10 to 14, according to the result of the final accepted split inference configuration control message, and the information carried by that message, as negotiated in step 5 of FIGS. 11 and 12, is shown.

Table 2 below shows the semantics of the control message for split configuration between the UE and server, and between the server and the UE.

TABLE 2
Control message for split configuration between a UE and server

| - | Definition | |
|---|---|---|
| -- | | Split configuration messages are used to ensure that the necessary |

delivery sessions required for AI media split service are established between
the UE and server. The message is typically delivered and used at the
beginning of a service session, but may also be delivered and used during a
service session if and when a split configuration change between the UE and
server is required.

| - | Behavior | |
|---|---|---|
| -- | From the server to the UE | |
| | --- | When configuration is decided by server |
| | --- | Typically when media data originates in server |
| | --- | Service entry point: 5GAI server app, or 5GAI AF |
| | --- | QoS request: 5GAI AF −> PCF/NEF/SMF |
| | --- | Message notifies UE to prepare for establishment of necessary DL/UL |

pipelines

| -- | From the UE to the server | |
|---|---|---|
| | --- | When configuration is decided by UE, or requested by UE |
| | --- | Typically when media data originates in UE |
| | --- | Service entry point: 5GAI UE app |
| | --- | Message notifies server of UE configuration request −> server OK's or |

sends an adjusted reply message in response

| | |
|---|---|
| --- | QoS request: AI data session handler −> 5GAI AF −> PCF/NEF/SMF |

Table 3 below shows the syntax of the control message for split configuration.

TABLE 3

| Type | Value | Syntax | Cardinality |
|---|---|---|---|
| Message_id | A unique value identifying this message: | Integer | 1 |
| | Example: 4123 | | |
| Message_size | An integer shows the length of the message | Integer | 1 |
| | body in bytes | (Double) | |
| Message_Type | “Split configuration” | String | 1 |
| Media_source | Notifies the source of the media data | Flag | 1 |
| | (video/audio) | | |
| Intermediate_source | Notifies the source of the AI intermediate data | Flag | 1 |
| Result_source | Notifies the source of the AI inference result | Flag | 0 . . . 1 |
| | data | | |
| Media_direction | Notifies the direction of the media data | Flag | 0 . . . 1 |
| | (video/audio) | | |
| Intermediate_direction | Notifies the direction of the AI intermediate | Flag | 0 . . . 1 |
| | data | | |
| Result_direction | Notifies the direction of the AI inference result | Flag | 0 . . . 1 |
| | data | | |

Cardinality: 0 = not allowed, 1 = only once, 0 . . . 1 = at most one, 0 . . . N = zero or more, and 1 . . . N = one or more.
In the above table:
1. For source: flag = 0 indicates UE as source, flag = 1 indicates server as source
2. For direction: flag = 0 indicates DL (server to UE), flag = 1 indicates UL (UE to server)

Syntax elements which include the suffix_source are used to indicate the source of the corresponding data type in the split inference configuration, where a flag value of 0 indicates the UE as the source, and where a flag value of 1 indicates the server as the source.

Syntax elements which include the suffix_direction are used to indicate the direction of delivery of the corresponding data type, where a flag value of 0 indicates downlink delivery (from server to UE), and where a flag value of 1 indicates uplink delivery (from UE to server).

The cardinality of each syntax element indicates the rules of the element's presence in the control message (i.e. whether it is mandatory or optional, and whether more than one element of the same type is allowed).

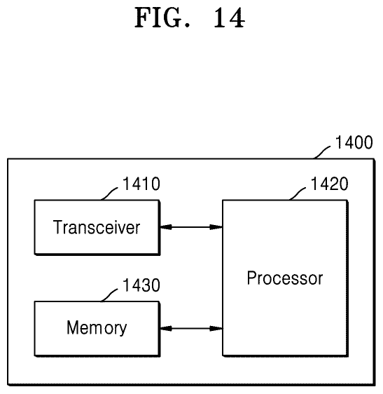

FIG. 14 is a block diagram of an entity 1400, according to an embodiment.

Referring to FIG. 14, the entity 1400 may be at least one of UE, network, or server, and perform aforementioned operations.

The entity 1400 may include a transceiver 1410, a processor 1420 and a memory 1430. Elements of the entity 1400 are not, however, limited thereto. For example, the entity 1400 may include more (e.g., a memory) or fewer elements than described above. The processor 1420, the transceiver 1410 and the memory 1430 may be implemented as a single chip.

The transceiver 1410 may be connected to the processor 1420 and may transmit or receive signals to or from another entity. The signal may include control information and data. The transceiver 1410 may receive a signal on a wired channel or wireless channel and output the signal to the processor 1420 or transmit a signal output from the processor 1420 on a wired channel or wireless channel. The transceiver 1410 may include an RF transmitter for up-converting and amplifying a transmitted signal, and an RF receiver for down-converting a frequency of a received signal.

The processor 1420 may control a series of processes for the entity 1400 to operate as described herein. The processor 1420 may include a controller or one or more processors.

A memory 1430 may store a program and data required for operation of the entity 1400. The memory 1430 may store the control information or the data included in a signal obtained. The memory 1430 may be connected to the processor 1420 and store at least one instruction or a protocol or a parameter for the proposed function, process, and/or method. The memory 1430 may include a storage medium such as a read only memory (ROM), a random access memory (RAM), a hard disk, a compact disc ROM (CD-ROM), and a digital versatile disc (DVD), or a combination of storage mediums.

Embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a field programmable gate array (FPGA) or application specific integrated circuit (ASIC), which performs certain tasks or provides the associated functionality.

The described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements.

Various combinations of optional features have been described herein, and it will be appreciated that described features may be combined in any suitable combination. In particular, the features one embodiment may be combined with features of any other embodiment, as appropriate, except where such combinations are mutually exclusive.

It is understood that blocks in flowcharts or combinations of the flowcharts herein may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

Each feature disclosed herein may be replaced by alternative features serving the same, equivalent or similar purpose, unless expressly stated otherwise. Thus, unless expressly stated otherwise, each feature disclosed is one example only of a generic series of equivalent or similar features.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a network, the method comprising:
identifying an artificial intelligence (AI) model corresponding to a service;
negotiating a split inference configuration with a user equipment (UE);
performing a split inference with the UE, based on the AI model and the split inference configuration; and
providing the service based on a result of the split inference.

2. The method of claim 1,
wherein negotiating the split inference configuration includes exchanging control messages with the UE.

3. The method of claim 1,
wherein negotiating the split inference configuration is based on at least one of AI model specific information, a capability of the UE, or a resource availability.

4. The method of claim 3,
wherein the AI model specific information includes at least one of a size of the AI model, a number of layers of the AI model, a number of nodes and links of each of the layers, complexity of each of the layers of the AI model, possible split points for the split inference, or a target inference delay.

5. The method of claim 1,
wherein the split inference configuration includes a split point for the split inference and an order of the split inference.

6. The method of claim 1, wherein performing the split inference with the UE comprises:
transmitting, to the UE, a first portion of the AI model to be inferenced on the UE;
obtaining a media for inference;
generating intermediate data by performing an inference on the media based on a second portion of the AI model; and
transmitting, to the UE, the intermediate data.

7. The method of claim 5,
wherein the media for inference is obtained from the UE.

8. The method of claim 5,
wherein the first portion of the AI model corresponds to a task specific portion, and wherein the second portion of the AI model corresponds to a common portion over multiple tasks.

9. The method of claim 1, wherein performing the split inference with the UE comprises:
transmitting, to the UE, a first portion of the AI model to be inferenced on the UE;
receiving, from the UE, intermediate data, the intermediate data being a result of an inference of media based on the first portion of the AI model;
performing an inference on the intermediate data based on a second portion of the AI model; and
transmitting, to the UE, a result of the inference of the intermediate data.

10. A method performed by a user equipment (UE), the method comprising:
negotiating a split inference configuration with a network;
performing a split inference with the network, based on an artificial intelligence (AI) model corresponding to a service and the split inference configuration; and
providing the service based on a result of the split inference.

11. The method of claim 10,
wherein negotiating the split inference configuration is based on at least one of AI model specific information, a capability of the UE, or resource availability.

12. The method of claim 10,
wherein the split inference configuration includes a split point for the split inference and an order of the split inference.

13. The method of claim 10, wherein performing the split inference with the network comprises:
receiving, from the network, a first portion of the AI model to be inferenced on the UE;
receiving, from the network, intermediate data, the intermediate data being a result of an inference of target media based on a second portion of the AI model; and
performing an inference on the intermediate data based on the first portion of the AI model.

14. The method of claim 13,
wherein the first portion of the AI model corresponds to a task specific portion, and wherein the second portion of the AI model corresponds to a common portion over multiple tasks.

15. The method of claim 10, wherein performing the split inference with the network comprises:
receiving, from the network, a first portion of the AI model to be inferenced on the UE;
obtaining media for an inference;
generating intermediate data by performing the inference on the media based on the first portion of the AI model;
transmitting, to the network, the intermediate data; and
receiving, from the network, a result of the inference of the intermediate data based on a second portion of the AI model.
